(19) United States
(12) Patent Application Publication
(10) Pub. No.: US 2004/0124993 A1
(43) Pub. Date: Jul. 1, 2004

(54) Systems and methods for guiding personnel to a location

(76) Inventor: Anthony George, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/705,267

(22) Filed: Nov. 10, 2003

Related U.S. Application Data
(60) Provisional application No. 60/425,007, filed on Nov. 8, 2002.

(51) Int. Cl. G08B 3/00

(52) U.S. Cl. 340/691.1; 340/524

(57) ABSTRACT

Systems and methods for guiding emergency personnel to a location after being in close proximity of the location are described. One embodiment of the method comprises recognizing a situation and activating at least one light source located at a location on recognizing the situation.

### CROSS REFERENCE TO RELATED APPLICATIONS

This application claims priority to U.S. Provisional Application entitled, “SYSTEMS AND METHODS FOR GUIDING EMERGENCY PERSONNEL TO A LOCATION AFTER BEING IN CLOSE PROXIMITY OF THE LOCATION,” having serial No. 60/425,007, filed on Nov. 8, 2002, which is entirely incorporated by reference.

### BACKGROUND

In an emergency, prompt attention from emergency personnel is extremely important. In some situations, mere seconds can determine the difference between life and death. For instance, during a medical emergency, such as a severe cut, a stroke, or a heart attack, an ambulance is needed within a short time so that the life of the person who is endangered, can be saved. As another instance, during an emergency caused by a fire, quick response by the fire department is needed to save lives of people in a burning structure and to combat the fire. As yet another instance, police are quickly needed when there is breaking and entering of one's residence or business to prevent theft of valuables or harm to occupants.

However, typical emergency systems, e.g. burglar alarms, generally do not facilitate the quick service during the emergencies. To illustrate, once an emergency vehicle, such as an ambulance, has reached an apartment community where a patient is in a severe condition, it takes additional time to find the particular location of the emergency. For instance, emergency personnel may need to locate and follow signs showing apartment numbers to reach the specific apartment in which the patient is located. It takes even more time if there are no signs showing apartment numbers since medical personnel may have to ask directions from people strolling in the apartment community to find the apartment.

Hence, a need exists in the industry to overcome the above-mentioned inadequacies of being unable to provide quick service during emergencies by pinpointing the location of the emergency.

### SUMMARY

Systems and methods for guiding emergency personnel to a location after being in close proximity to the location, are described. One embodiment of the method comprises recognition of a situation and activation of at least one light source located at the location of the situation and indicating the location thereof.

One embodiment includes a system for indicating a precise location of an emergency situation including a light source located at the location that when activated, is visible to emergency personnel. The embodiment includes a circuit for activating the light source in the event of an emergency.

Another embodiment includes a system for indicating a specific location including a switch to activate a combination of light sources electrically coupled to the switch. The combination of lights provide a trail to direct emergency personnel to the specific location.

### BRIEF DESCRIPTION OF THE DRAWINGS

Many aspects of the disclosed systems and methods can be better understood with reference to the following drawings. The components in the drawings are not necessarily to scale, emphasis instead being placed upon clearly illustrating the relevant principles. Moreover, in the drawings, like reference numerals designate corresponding parts throughout the figures.

FIG. 1 shows an elevation view of an embodiment of a representative apartment community in which an embodiment of the present systems and methods can be implemented;

FIG. 2 shows a block diagram of an embodiment of a system that guides emergency personnel to a location; and

FIG. 3 shows another embodiment of the system.

### DETAILED DESCRIPTION OF THE PREFERRED EMBODIMENT(S)

Systems and methods that guide emergency personnel to a location after they have arrived in close proximity of the location, are described. The systems and methods overcome the above-mentioned inadequacies by activating at least one light source. During the emergencies, once an emergency vehicle is in close proximity to a location where the emergency occurred, personnel inside the emergency vehicle can reach the location once they see the at least one light source. The light source may be an amber light, red light, or any other color-coded light which, preferably, is visible to the personnel.

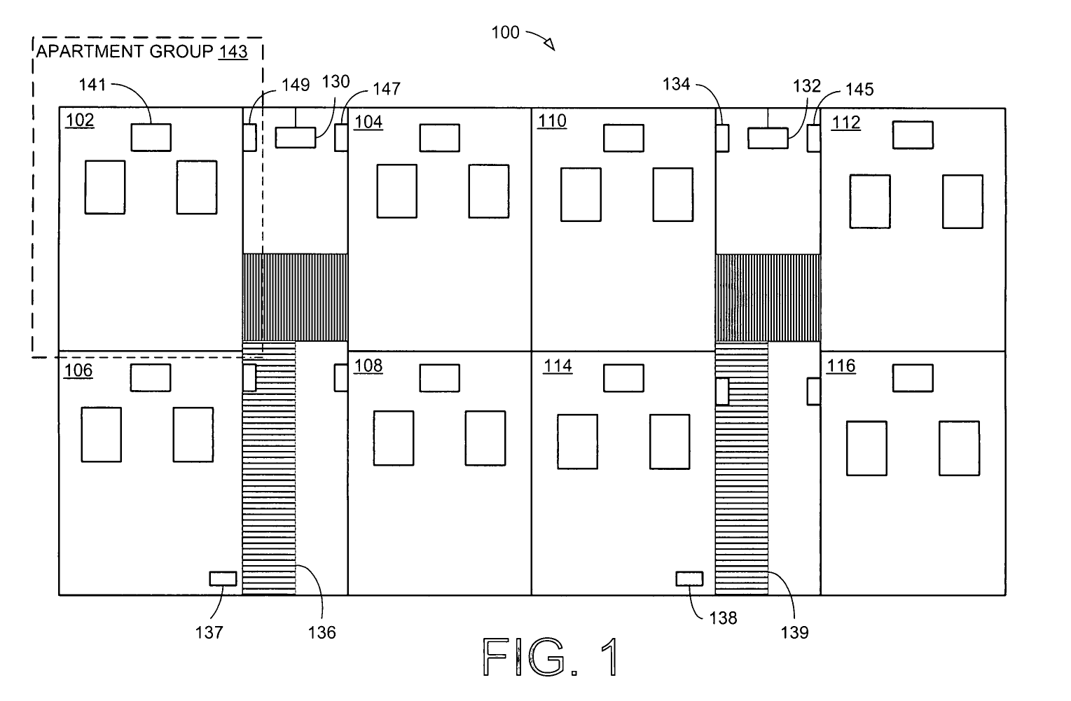

FIG. 1 shows an elevation view of an embodiment of an apartment community 100 in which the systems and methods can be implemented. It is noted that the systems and methods alternatively can be implemented in a community of houses, in office buildings, hotels, motels, shopping centers, or other locations that may need to be quickly located. The apartment community 100 is a single structure and has twenty-four apartments, eight of which are apartments 102, 104, 106, 108, 110, 112, 114, and 116. The remaining sixteen of the twenty-four apartments are directly behind apartments 102, 104, 106, 108, 110, 112, 114, and 116, and thus, are not shown in FIG. 1. For example, two of the remaining sixteen apartments are located directly behind the apartment 102, and two other apartments are located directly behind apartment 106 and so on Any one of the apartments 102, 104, 106, 108, 110, 112, 114, and 116 in combination with the two apartments located directly behind them are referred to as an apartment group. For example, apartment group 143 comprises apartment 102 and the two apartments located directly behind it (not-shown). It is noted that the apartment community 100 can have more or less than twenty-four apartments. Likewise, an apartment group may include any combination or collection of apartments typically located within the same building.

Each apartment group has at least one light source, such as a light source 141, which when activated, is visible to emergency personnel in an emergency vehicle that has reached the apartment community 100. The emergency vehicle that has reached the apartment community 100 is in close proximity to each apartment of the apartment community 100. When activated, the at least one light source of each apartment group guides emergency personnel, who have reached the apartment community 100, to the apartment group having the emergency. If there is no light source outside each of the apartment groups or if the at least one light source is not activated, it takes more time for the personnel to locate an apartment in which there is an emergency. Without the present system, emergency personnel typically must locate and read signs, such as 130 and 132, to locate the apartment with the reported emergency. Signs 130 and 132 are boards typically printed or painted with text representing a range of apartment numbers. For example, sign 130 is a board showing a range of apartment numbers for directing visitors to apartments 102, 104, 106, 108, and the apartments located behind them. Sign 132 is a board showing a range of apartment numbers for directing visitors to apartments 110, 112, 114, and 116, and the apartments located behind them. In a worst-case scenario, in which there are no signs in the apartment community 100 or the signs are obscured or unreadable, the personnel typically use the time-consuming method of visiting each apartment in apartment community 100 to locate the specific apartment reporting the emergency. Looking to FIG. 1, for instance, the personnel may also have to climb each set of stairs 136 and 139 before they locate the apartment.

An entrance (not shown), such as a front-door entrance, of each apartment in the apartment community 100, may also have at least one light source located adjacent to the entrance of the apartment. For instance, entrance-light source 145 is located adjacent to a front-door entrance of the apartment 112, entrance-light source 147 is located adjacent to a front-door entrance of the apartment 104, and entrance-light source 149 is located adjacent to a front door entrance of apartment 102. The emergency personnel who have reached an apartment group 143, can see the specific apartment that has an entrance adjacent to which the entrance light is activated, and can quickly reach the apartment to attend to the reported emergency. One will appreciate that the light source located adjacent to the entrance of the apartment may be used alone, or in combination with other light sources to direct the personnel to the specific apartment. For example, entrance light source 149 may be used alone, or in combination with light source 141. By combining several light sources, a light trail is provided to emergency personnel who may easily follow the lights to the emergency.

In another embodiment, a light source can correspond to a set of stairs. For example, a stair-light source 137 corresponds to the set of stairs 136 and a second stair-light source 138 corresponds to the set of stairs 139. Having a light source that corresponds to a set of stairs overcomes the problem of the personnel climbing each set of stairs 136 and 138 before locating the apartment with the emergency. It should be understood that the stair light may be used in combination with other light sources to direct the personnel to the proper apartment. For instance, stair light 137 can be used alone or in combination with light source 141 and/or door light 149 to direct personnel to the specific apartment with the reported emergency. By combining several light sources, a light trail is provided to emergency personnel who may easily follow the lights to the emergency.

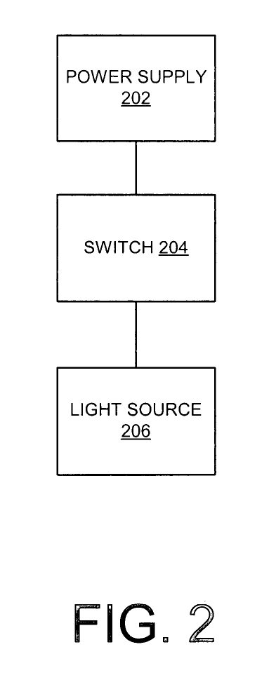

FIG. 2 shows a block diagram of an embodiment of a system that guides emergency personnel to proceed to a location after being in close proximity of the location. The system comprises a power supply 202 that is electrically coupled via a switch 204 to a light source 206. It is noted that more than one light source, such as light sources 134 and 138 in FIG. 1, can be coupled to the power supply 202 via the switch 204. An example of power supply 202 may be a battery or normal local power (AC) source. Preferably, the source of power does not rely on local power. For instance, the power source may use local power, but may also employ a battery backup system in the event of the failure of local power. A non-exhaustive list of examples of light source 206 are incandescent bulbs, fluorescent lights, LEDs, rope lights, neon lights, and tubelights. When the switch 204 electrically couples the power supply 202 to the light source 206, the light source 206 is activated and emits light. Light source 206 may be flashing, or may be a solid light. In the preferred embodiment, light source 206 emits light periodically at intervals of a few seconds, such as 2 seconds, 3 seconds, or 4 seconds. A light source that emits light periodically is less likely to be confused with pre-existing illuminants. It should be understood that light source 206 may also use other techniques to help visibility and distinguish it from other lights. For example, light source 206 may change colors, or if light source 206 is made from an array of LEDs, the array of LEDs may be configured to display a message. It should be understood that light source 206 can emit visible light of any color.

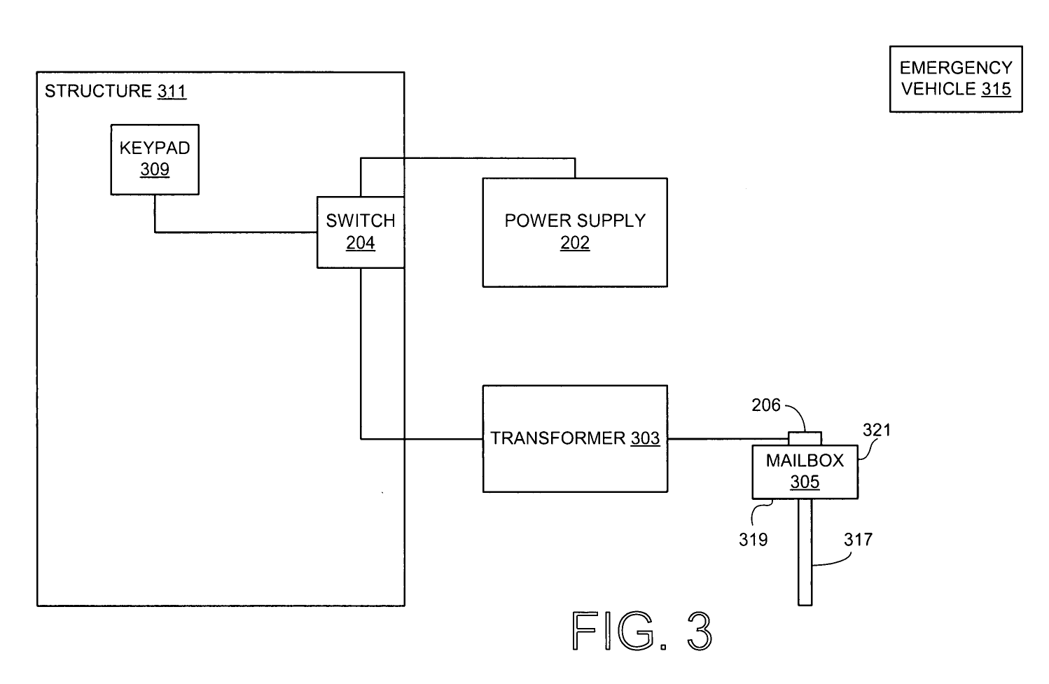

FIG. 3 shows another embodiment of the system for guiding emergency personnel to a location after being in close proximity of the location. The system comprises the power supply 202, the switch 204, and the light source 206. The power supply 202 is electrically coupled via the switch 204 and a transformer 303 to the light source 206. The switch 204 is electrically coupled to the transformer 303 and a keypad 309. Keypad 309 may, for example, be integrated with a security system as commonly found in homes and offices. It is noted that instead of being coupled to the keypad 309, the switch 204 can be electrically coupled to a computing device (not shown), such as a computer, or can be electrically coupled to a telephone (not shown). The transformer 303 is electrically coupled to the light source 206.

During an emergency, a person in a structure 311, such as a house, an apartment group, or an apartment, establishes an electrical connection between the power supply 202 and the transformer 303 by pressing one or more keys such as “9-1-1” on the keypad 309. In an alternative embodiment, the electrical connection can be established by pressing keys of an output device, such as a keyboard, of the computing device. In yet another alternative embodiment, the electrical connection can be established by pressing keys on a keypad of a telephone. In still another embodiment, the electrical connection can be established by simply toggling the switch 204, which can be, for example, a bedside panic button. The connection is established because the switch 204 electrically couples the power supply 202 to the transformer 303 after the keys are pressed.

Once the keys are pressed, the power supply 202 is also electrically coupled to the light source 206 via the switch 204 and the transformer 303. The electric coupling between the power supply 202 and the light source 206 activates the light source 206. The light source 206 emits light once it is activated and preferably, as stated before, the emission is at periodic intervals. The personnel in an emergency vehicle 315 can see the light source 206 and recognize that there is a medical emergency at the location of the structure 311. Hence, the personnel can quickly locate the structure 311.

In the present embodiment, light source 206 is located on top of a mailbox 305. In an alternative embodiment, multiple light sources may be located on the mailbox 305 or on a pole 317 supporting the mailbox. For example, a second light source (not shown) can be located on a bottom surface 319 of the mailbox 305 and a third light source (not shown) can be located on a side surface 321 of the mailbox 305. In yet another alternative embodiment, at least one light source can be located on the structure 311. For example, the light source 206 can be a porch light outside a house. It is noted that the power supply 202 and the transformer 303 can be located inside the structure 311. It is also noted that the switch 204 can also be in a security alarm circuit (not shown) to activate the alarm and alert neighbors of the emergency, such as a fire in a building.

It should be emphasized that the above-described embodiments, particularly, any “preferred” embodiments, are merely possible examples of implementations, merely set forth for a clear understanding of the principles of the systems and methods for guiding personnel to a location. Many variations and modifications may be made to the above-described embodiment(s) without departing substantially thereof. All such modifications and variations are intended to be included herein within the scope of this disclosure and protected by the following claims.

Therefore, having thus described the invention, at least the following is claimed:

1. A method for guiding emergency personnel to a location after being in close proximity of the location, comprising:
recognizing a situation; and
activating at least one light source located at the location on recognizing the situation.

2. The method of claim 1, further comprising:
emitting a periodic light from the at least one light source to attract emergency personnel to the location.

3. The method of claim 1, wherein the activating comprises one of activating a switch that is coupled to the at least one light source and pressing at least one key of a device that is coupled to the switch.

4. The method of claim 3, wherein the pressing is performed by at least one of pressing at least one key on a keypad of a telephone, pressing at least one key on an output interface of a computing device, and pressing at least one key on a keypad of a security system.

5. The method of claim 1, wherein the recognizing comprises recognizing an emergency.

6. A system for indicating a precise location of an emergency location, comprising:
at least one light source that is located at the location and, when activated, is visible to emergency personnel; and
circuit means for activating the at least one light source in the event of an emergency.

7. The system of claim 6, wherein the at least one light source is located on a mailbox.

8. The system of claim 6, further comprising a second light source electrically coupled to the circuit means to provide a trail to direct emergency personnel to the location when activated.

9. The system of claim 6, wherein the circuit means comprises a switch coupled to the at least one light source and a device comprising at least one key coupled to the switch.

10. The system of claim 9, wherein the device is selected from the group consisting of: a telephone, a computer keyboard, and a security alarm keypad.

11. A system for indicating a specific location, comprising:
a switch used to activate at least one light source in an emergency; and
a combination of a first light source and a second light source electrically coupled to the switch, the combination providing a trail to direct emergency personnel to the specific location.

12. The system of claim 11, wherein the specific location is an apartment located within an apartment group.

13. The system of claim 11, wherein the first light source is located at the entrance of the specific location, and the second light source is located in close proximity to a stairwell used to access the specific location.

14. The system of claim 11, wherein the first light source is located at the entrance of the specific location, and the second light source indicates a collection of locations, including the specific location.

15. The system of claim 14, wherein the specific location is an apartment, and the collection of locations is an apartment group.

16. A method for guiding emergency personnel to a location after being in close proximity of the location, comprising:
recognizing an emergency situation;
activating a first light source and a second light source; and
directing emergency personnel to the location using a combination of the first light source and the second light source.

17. The method of claim 16, further including:
activating a switch that is coupled to the first light source by pressing at least one key of a device that is coupled to the switch.

18. The method of claim 16, further including:
placing the first light source at an entrance of the location; and
locating the second light source on a mailbox.
